(19) United States
(12) Patent Application Publication
(10) Pub. No.: US 2016/0140672 A1
(43) Pub. Date: May 19, 2016

(54) Mobile Social Activity Networking Systems and Methods

(71) Applicant: YR Tech, LLC, Fort Worth, TX (US)

(72) Inventors: Jonathan Joseph SHNITZER, Fort Worth, TX (US); Ricardo BARREDA, III, Fort Worth, TX (US)

(21) Appl. No.: 14/827,938

(22) Filed: Aug. 17, 2015

Related U.S. Application Data
(60) Provisional application No. 62/079,149, filed on Nov. 13, 2014.

(51) Int. Cl. G06Q 50/00; G06F 3/0488; G06F 3/0484; G06F 3/0482; G06Q 10/10; G06F 17/30

(52) U.S. Cl. CPC G06Q 50/01; G06Q 10/109; G06F 17/30241; G06F 17/30876; G06F 17/30867; G06F 3/04842; G06F 3/0482; G06F 3/0488

(57) ABSTRACT

Mobile social activity networking systems and methods with geographical vicinity preferences are disclosed. The system/methods include mobile computing devices (MCDs) communicating over a network. The MCDs are equipped with global positioning system (GPS) to keep track of their geographic location. Users download an activity network application (ANA) from a mobile application server (MAS. Using the ANA, users input criteria such as a distance and other preferences, for example, event/activity and proficiency. The application searches for other users within the distance (using GPS data) and matches users based on the input preferences. The user can perform an action to accept the matched profile. The user may send an invitation to connect with the system-matched user(s) and, upon acceptance, the users are connected. The connected users can message each other or share electronic calendars to plan events/activities.

### CROSS REFERENCE TO RELATED APPLICATIONS

This application claims priority to provisional patent application No. 62/079,149, filed Nov. 13, 2014.

### FIELD OF THE INVENTION

The present invention generally relates to mobile social networking, and more particularly relates to mobile applications software and systems that match users based on specific activity interests within a user-selected geographic distance with a global positioning system.

### DESCRIPTION OF THE RELATED ART

Social networking has become a significant aspect of many people's lives as they communicate with others who are members of the same social networking applications. In many instances, members who have joined these social networks to find other individuals with similar interests but may be unaware that every day they are passing hundreds of people some of who may also have these same interests.

Social networks may often specify three levels of social connections. These may include immediate family and close friends, extended friends, and “shared interest” groups. Today users interact sporadically, but intensely, with extended friends and extended friends through games, avatars, and general updates and information. Users with common interests also may communicate in ways that extend into business. The popularity of social networking in business, for trading, online collaboration, and virtual meetings continues to grow. With the ubiquity of “mobile apps”, more heretofore unrealized social connections may now be possible.

### BRIEF SUMMARY

The present invention in various embodiments addresses one or more of the above objectives in the following manner.

An exemplary embodiment of the includes a mobile computing devices (MCDs) communicating over a network. The MCDs are enabled to keep track of user geographic location through a global positioning system (GPS). Users download an activity network application (ANA) from a mobile application server (MAS) through a mobile web server (MWS). Using the activity network application, the users may each choose a range of distance from himself/herself, and preferences that include, for example, demographic criteria, and “activity interest data” indicating degree of proficiency. The system searches for users matching the input preferences within the selected distance, in real time, using the GPS data of users. The system, for example, matches users found with the user-selected distance criterion with other users having matching activity and demographic criteria. These “system-matched users” are presented to the user that is requesting an activity. The requesting user can user can perform an activity to accept or reject the presented system-matched user profiles. For example, the user may swipe up to reject or swipe down on a touch screen of a mobile device to accept the accepted matched user. The user may then send an invitation to connect with the accepted system-matched profile. Upon acceptance of the invitation, the users are connected. The connected users can message each other or share/compare calendars to plan activities. Connected users and their connections with a matching profile of interests may join and participate in the event.

The term “event” herein may include an activity (such as a sports activity in which the users participate as players) and is not limited to an event, such as attending a sports match as spectators, or rock concert, or like entertainment, for example.

### Method Overview

The inventive systems may be utilized in the context of an overall mobile activity networking method, wherein the mobile activity networking display system described previously is controlled by a method having the following steps:
(1) with an MCD, connecting to a network;
(2) loading an activity networking application into the MCD;
(3) authenticating through a social networking application;
(4) choosing activities indicating proficiency level and selecting distance to search;
(5) perform search with the application and retrieve matching user profiles on the MCD;
(6) browsing through the matching user profiles and performing an action to accept or reject a user profile;
(7) sending a request via the application to an accepted user matching the profile;
(8) receiving a response from the user with the matching profile; and connecting with the user of the matching profile.

Integration of this and other exemplary embodiment methods in conjunction with a variety of exemplary embodiment systems described herein in anticipation by the overall scope of the present invention.

### BRIEF DESCRIPTION OF THE DRAWINGS

For a fuller understanding of the advantages provided by the invention, reference should be made to the following detailed description of exemplary embodiments together with the accompanying drawings wherein:

FIG. 1 illustrates an activity networking system according to an exemplary embodiment of the present invention.

FIG. 2 illustrates a global positioning system in an activity networking system according to an exemplary embodiment of the present invention.

FIG. 3 illustrates another global positioning system in an activity networking system according to an exemplary embodiment of the present invention.

FIG. 4 illustrates an activity networking connection flowchart method according to an exemplary embodiment of the present invention.

FIG. 5 illustrates an activity networking system settings menu according to an exemplary embodiment of the present invention.

FIG. 6 illustrates an activity networking system activities selection menu according to an exemplary embodiment of the present invention.

FIG. 7 illustrates an activity networking system activities selection menu with icons according to an exemplary embodiment of the present invention.

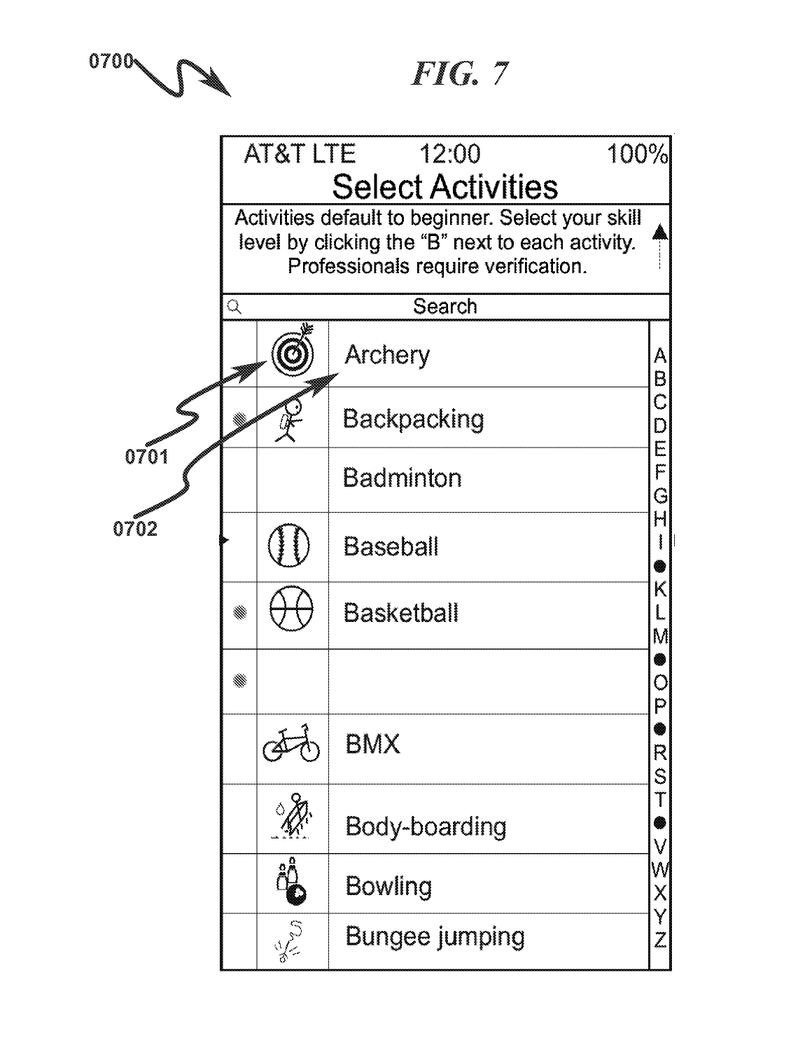

FIG. 8 illustrates an activity networking system activities selection menu with proficiency levels according to an exemplary embodiment of the present invention.

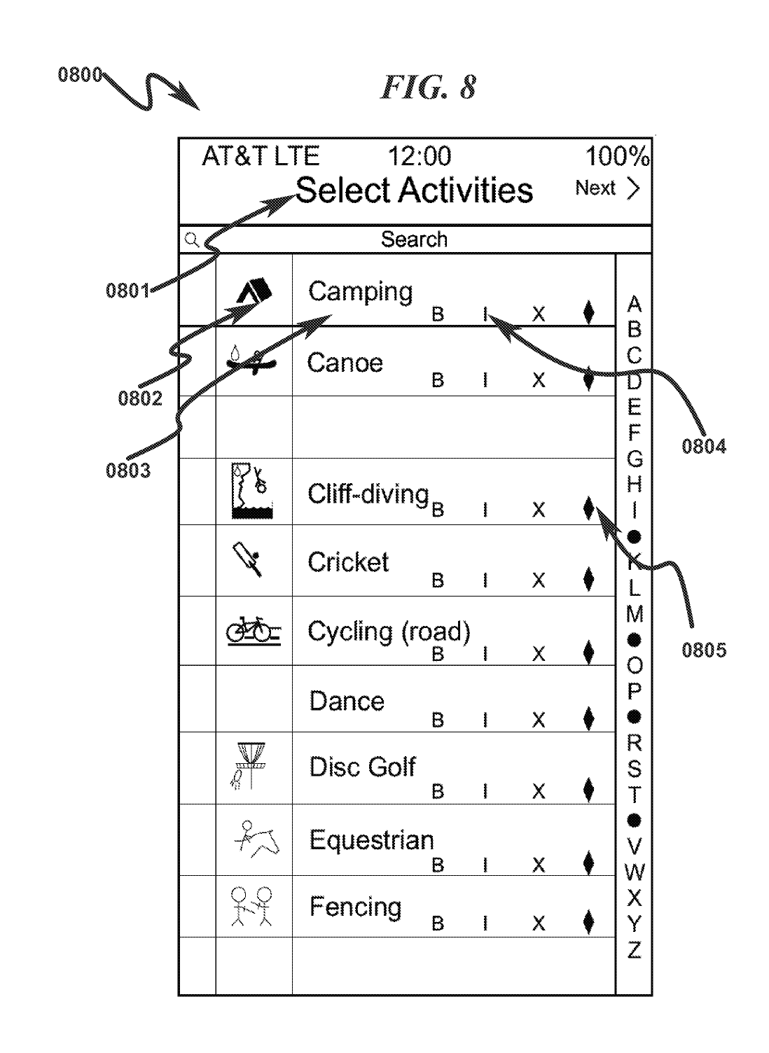

FIG. 9 shows matched profiles of users according to an exemplary embodiment of the present invention.

FIG. 10 shows selection or rejection of matched profiles of users by swiping according to an exemplary embodiment of the present invention.

FIG. 11 shows complete profile of a matched profile of a user according to an exemplary embodiment of the present invention.

FIG. 12 illustrates an activity networking invitation flowchart method describing an exemplary embodiment of the present invention.

FIG. 13 illustrates an activity networking messaging flowchart method describing an exemplary embodiment of the present invention.

FIG. 14 illustrates an activity networking system messaging menu according to an exemplary embodiment of the present invention.

FIG. 15 illustrates an activity networking system messages display according to an exemplary embodiment of the present invention.

FIG. 16 illustrates an activity group networking flowchart method describing an exemplary embodiment of the present invention.

FIG. 17 illustrates an activity networking system “Go Active” menu according to an exemplary embodiment of the present invention.

FIG. 18 illustrates an activity networking system “Go Active” screen according to an exemplary embodiment of the present invention.

FIG. 19 illustrates a user dating flowchart method describing an exemplary embodiment of the present invention.

FIG. 20 illustrates a user snap reporting flowchart method describing an exemplary embodiment of the present invention.

### DETAILED DESCRIPTION OF THE EXEMPLARY EMBODIMENTS

While the technology disclosed herein is susceptible of embodiment in many different forms, there is shown in the drawings, and will herein be described in detail, at least some of the exemplary embodiments, with the understanding that this description is to be considered as an exemplification of the principles and does not limit the broad aspects of the inventions, which are only defined by the patent claims.

The numerous innovative teachings of the present application will be described as advantageously applied to the particular problems of a pre-loader graphic display system and method. However, it should be understood that the disclosed embodiments are only exemplary and do not limit the many advantageous uses of the innovative teachings herein. In general, statements made in the specification of the present application do not limit any of the various claimed inventions unless so specified. Moreover, some statements may apply to some inventive features but not to others.

### Deficiencies in the Prior Art

The prior art as detailed above suffers from the following deficiencies:

A need has now been identified for social networking between unrelated people, who do not know each other at the outset, but reside (or are in transit, or at a travel destination or stop) within a range of distance of each other (such as for example, within a common neighborhood, city, or within a few miles range for ease of travel to meet up, etc.), and who share common interests such as sports, training, concerts, etc. to communicate, meet and conduct social activity through use of a common mobile device application.
Prior art systems do not generally provide for connecting geographically proximal users (i.e. those within a user specified distance from the user) based on activity interests and proficiency.
Prior art systems generally do not provide a messaging and invitation method to connect geographically proximal users based on activity interests and proficiency.
Prior art systems generally does not provide a method for group activity networking to initiate, broadcast and conduct a group event based on activity interests.
Prior art systems generally do not provide a method for travelling users to perform matching networking activities at the travelled place.
Prior art systems do not generally provide a system/method to report inappropriate content with a screenshot.
Prior art systems do not generally provide a method for networking users with interests in rare/uncommon activities and sports.

While some of the prior art may teach some solutions to several of these problems, the core issue of connecting users based on activity and distance criteria is not addressed by prior art.

### Exemplary Objectives of the Technology

Accordingly, the objectives of the technology are (among others) to circumvent the deficiencies in the prior art and affect the following objectives:
Provide for connecting geographically proximal users (i.e. those within a user specified distance from the user) based on user specified activity interests and proficiency.
Provide a messaging and invitation method to connect geographically proximal users based on activity interests and proficiency.
Provide a group activity networking via a communications application configured on a mobile device to initiate, broadcast and conduct a group event based on activity interests.
Provide a method for travelling users to perform matching networking activities at the destination of their travel activity.
Provide a system/method to report inappropriate content, for example, with a screenshot.
Provide a method for networking users with interests in rare/uncommon activities and sports.

While these objectives should not be understood to limit the teachings of the present invention, in general these objectives are achieved in part or in whole by the disclosed exemplary embodiments that are discussed in the following sections. One skilled in the art will no doubt be able to select aspects of the present exemplary embodiment as disclosed to effect any combination of the objectives described above.

### An Exemplary Embodiment Mobile Social Activity Networking System Diagram (0100)

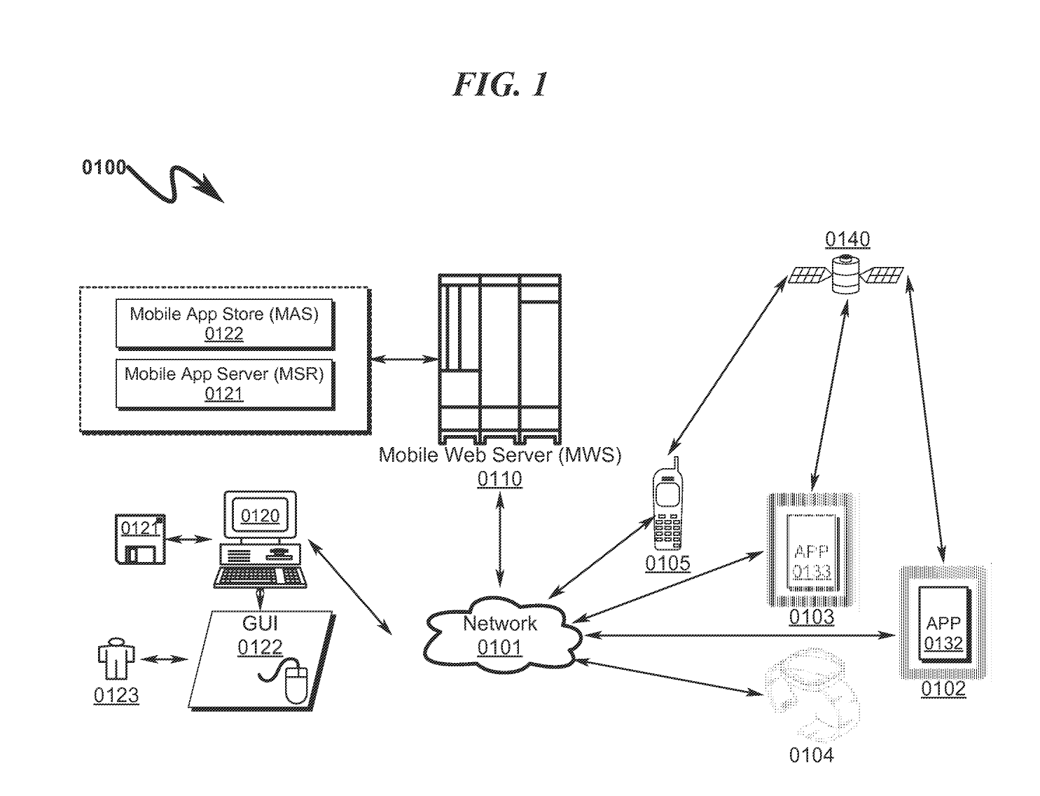

An example of the present inventive technology may be seen in more detail as generally illustrated in FIG. 1 (0100), wherein plural mobile computing devices (0102, 0103), wireless devices (0105), smart watch (0104) are connected to a network (0101). The network (0101) may include a wired protocol such as Ethernet or wireless protocol such as 3G, 4G, WIFI, NFC, WLAN, and LTE. A MWS (0110) is configured to connect to a network connecting plural mobile computing devices (MCDs) (0102, 0103, 0104, 0105) to a mobile application server (MSR) (0121). A user computing device (UCD) (0120) connects to the MWS (0110) to enable a user to access the MSR (0121).

The UCDs (0120) is/are configured for enabling users such as web site administrators, mobile application developers to interact with the MWS (0110) and the MSR (0121). The UCDs (0320) may further comprise a microprocessor executing instructions read from a computer-readable medium (0121) and a graphical user interface (GUI) (0122) with a pointing device. The users may open the GUI (0122) and upload mobile activity networking application (ANA) to the MAS (0122). The administrators may receive requests through the UCD (0120) or manually. Subsequently, they may process and upload updates to the MSR (0121).

The MCDs are equipped with global positioning devices to connect to a global positioning system (GPS) (0140). The GPS (0140) keeps tracks of the MCDs (0102, 0103, 0104, 0105) location which is used to determine distances between multiple MCDs. According to an exemplary embodiment, the ability to determine a distance and report back to the activity networking application on the MCDs (0102, 0103, 0104, 0105) enables the mobile social-activity networking application to match users based on the distance. The users are system-matched by the social networking activity application in real time based on the user input preferences. The activity-based social networking application may further facilitate event planning and coordinate activities between the system-matched users of the system. The user preferences may include demographic data defining other users the user wants to interact with, preferred activities the user wants to engage in, the preferred geographic range of proximity to the user of other users the user wants to communicate with.

### Mobile Application Server (MSR) (0121)

Mobile application server (0121) refers to a server that hosts, installs, and operates mobile applications and other services. The mobile application server may contain both a server operating system and server hardware. These function simultaneously to allow the server to provide remote access and services to apps, which can include authentication, updates, and security features. In this system, the mobile application server (0121) communicates with the client component, which operates on the mobile device (MCD) to receive apps, download updates, and follows the commands of the server. All of these functions occur over the network (0101). This allows the administrator of the system to configure app settings, send out updates, and wipe all data from a remote location.

In a mobile application server, the key features may include user management, data redundancy, security of the application and data, high levels of availability, a centralized interface for management, and load balancing. The MSR (0121) may be connected to a mobile application store (MAS) (0122) that stores plurality of mobile applications. A user may request to download or update an application through the MWS (0110). According to an exemplary embodiment application administrators may receive inappropriate content reports from users and act accordingly upon verification by an embedded code in a provided screen snapshot.

### Exemplary Embodiment Global Positioning System Block Diagram (0200-0300)

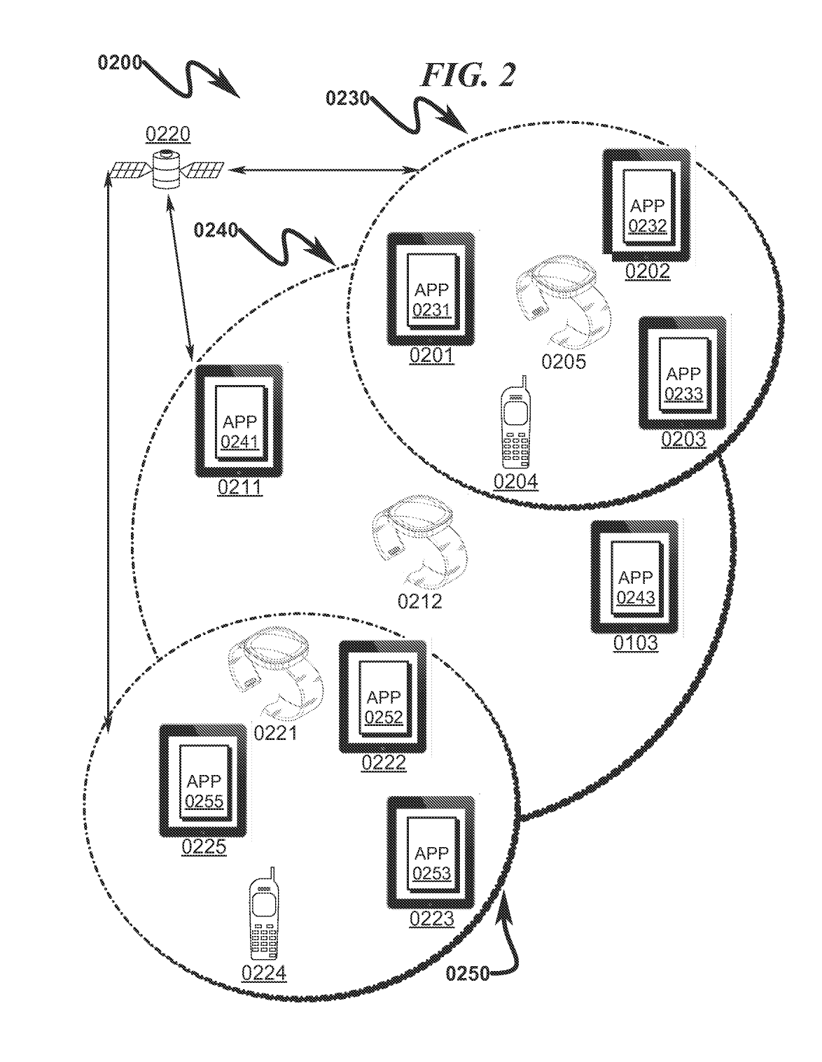

As generally illustrated in FIG. 2 (0200), users carrying plural mobile computing devices are physically located within separate distance circles (0230, 0240, 0250). The mobile devices are enabled with global positioning devices that connect to a global positioning system for keeping track of the location of the mobile devices. Based on a given location, a distance is calculated by the activity-based social networking application (ANA) of all the other devices (mobile computing devices). The calculated distance is further used to determine all available users within a certain circle. For example circle (0230) may comprise plural users with MCDs (0201, 0202, 0203, 0204). Similarly circle (0240) may comprise plural users with MCDs (0211, 0212, 0203, 0221, 0204, 0201) and likewise circle (0230) may comprise plural users with MCDs (0201, 0202, 0203, 0204). A user with MCD (0212) may set a larger distance than user with MCD (0205). Hence, the user with MCD (0212) may have a larger user base to connect and perform activities. Users constrained with distance may opt to set smaller distance in the setting menu and may have to wait longer time to find a match or switch activities to match with other users in the distance circle.

A travelling user may also use the application to set up a distance when travelling to a new place. The user may connect with other users based on a lodging location and an activity preference. The distance circle associated with the user is recalculated based on the travelling location. According to an exemplary embodiment, the application enables the user to recalculate distance/proximity circles and search for matching profiles. For example, a user travelling to a location may prefer to play tennis and set a preferred distance of 10 miles. Since it involves playing with a partner, the user may set the distance and preset tennis as an activity with proficiency level on the mobile activity networking application. The user may use standardized USIA tennis ratings such as 3.0, 3.5 or 4.0. Upon initiating a search with the activity networking application, users within 10 miles with a tennis interest and similar rating display on the user's activity application. The user may select a user based on the profile and other criteria. The user may message or invite the matched user for playing tennis upon agreeing on a location and time.

According to an exemplary embodiment, the activity application enables a travelling user to search for users with similar/matching activity interests (user preferences) within a certain distance of his location, which is readily ascertained by GPS, and communicated to the social activity networking application and the system.

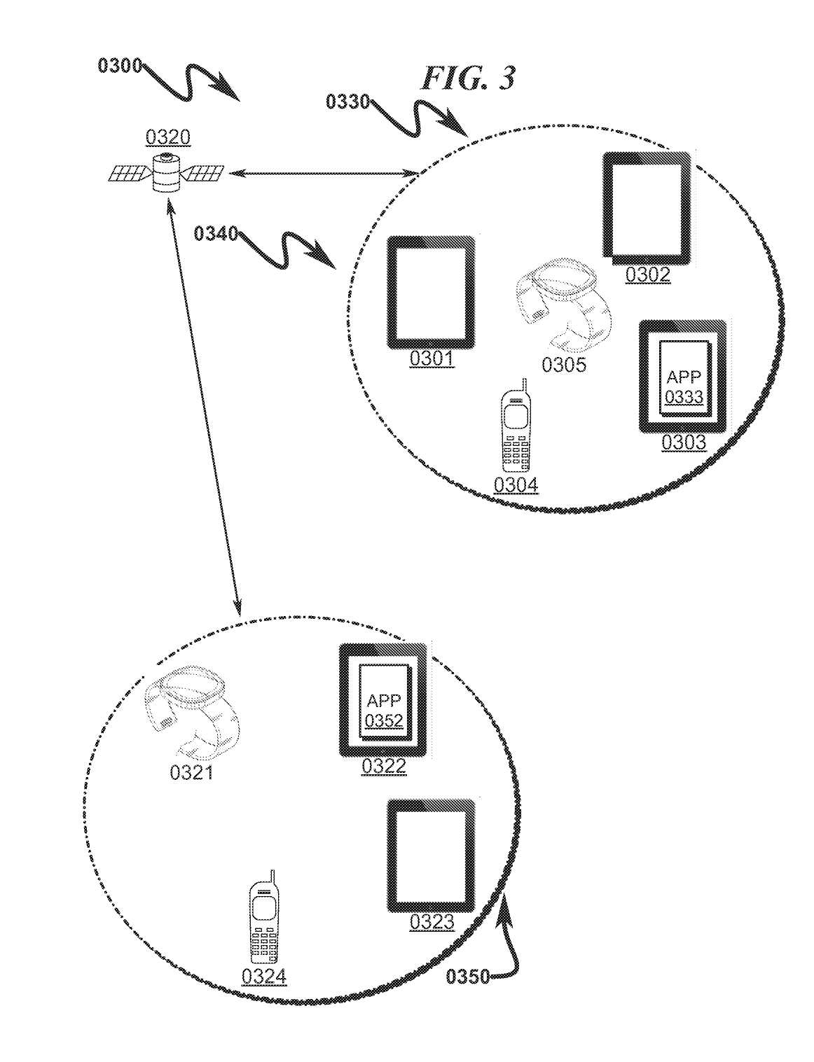

As generally illustrated in FIG. 3 (0300), users carrying plural mobile computing devices are physically located within separate distance circles (0330, 0350). The mobile devices are enabled with global positioning devices that connect to a global positioning system for keeping track of the location of the mobile devices. According to an exemplary embodiment, with the activity-based social networking application a user may search for users with similar/matching activity interests within a certain radius of distance, within the circle, for example. Thus, for example, the user (0321) may pre-select a distance that enables the ANA to search within distance circle (0350).

### Exemplary Embodiment Social Activity Networking Connection Method (0400)

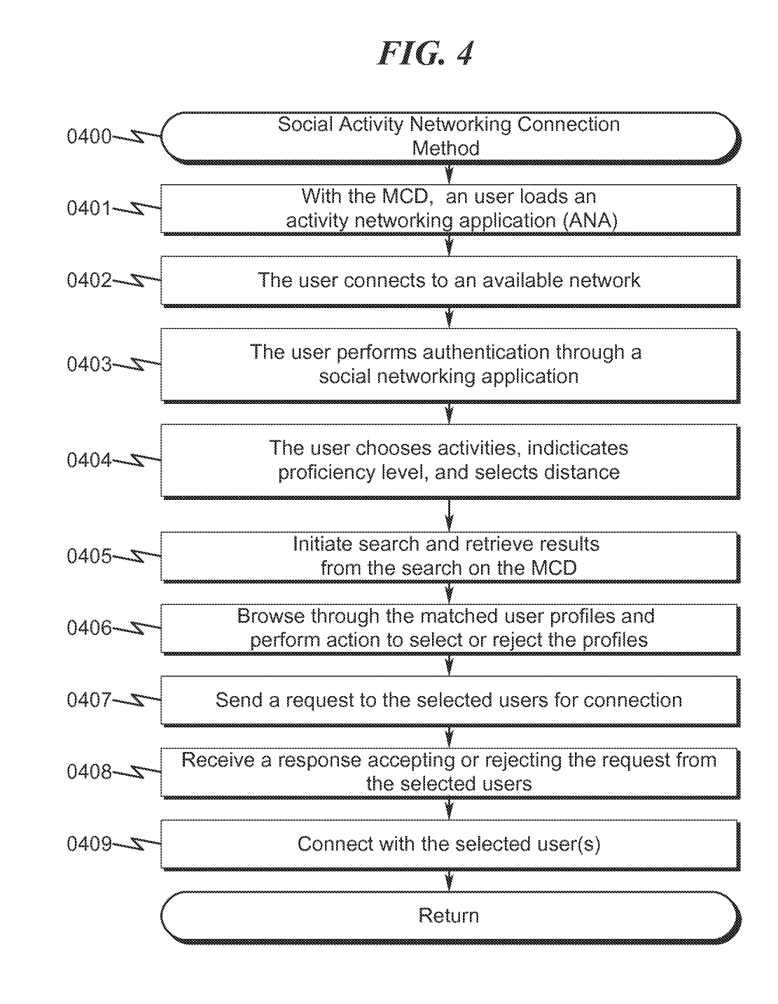

As generally seen in the flow chart of FIG. 4 (0400), the example of the present social activity networking connection methods may be described in terms of the following steps:
(1) with the MCD, connecting to a network (0401);
(2) loading an activity-based social networking application into the MCD (0402);
(3) authenticating through a social networking application (0403);
(4) choosing activities indicating proficiency level and selecting distance to search (0404);
   The user preferences may include demographic data defining other users the user wants to interact with, preferred activities the user wants to engage in, the preferred geographic range of proximity to the user of other users the user wants to communicate with.
(5) perform search with the activity-based social networking application and retrieve matching user profiles (system-matched users) on the MCD in real time (0405);
(6) Browse through the matched user profiles and perform action to select or reject the system-matched users (0406);
(7) sending a request with the application to a user of the matched profile (0407);
(8) receiving a response from the user of the matched profile (0408); and
(9) connecting with the user of the matched profile (0409).

One skilled in the art will recognize that these method steps may be augmented or rearranged without limiting the teachings of the present invention. This general method summary may be augmented by the various elements described herein to produce a wide variety of exemplary embodiments.

### An Exemplary Embodiment Application Settings Menu (0500)

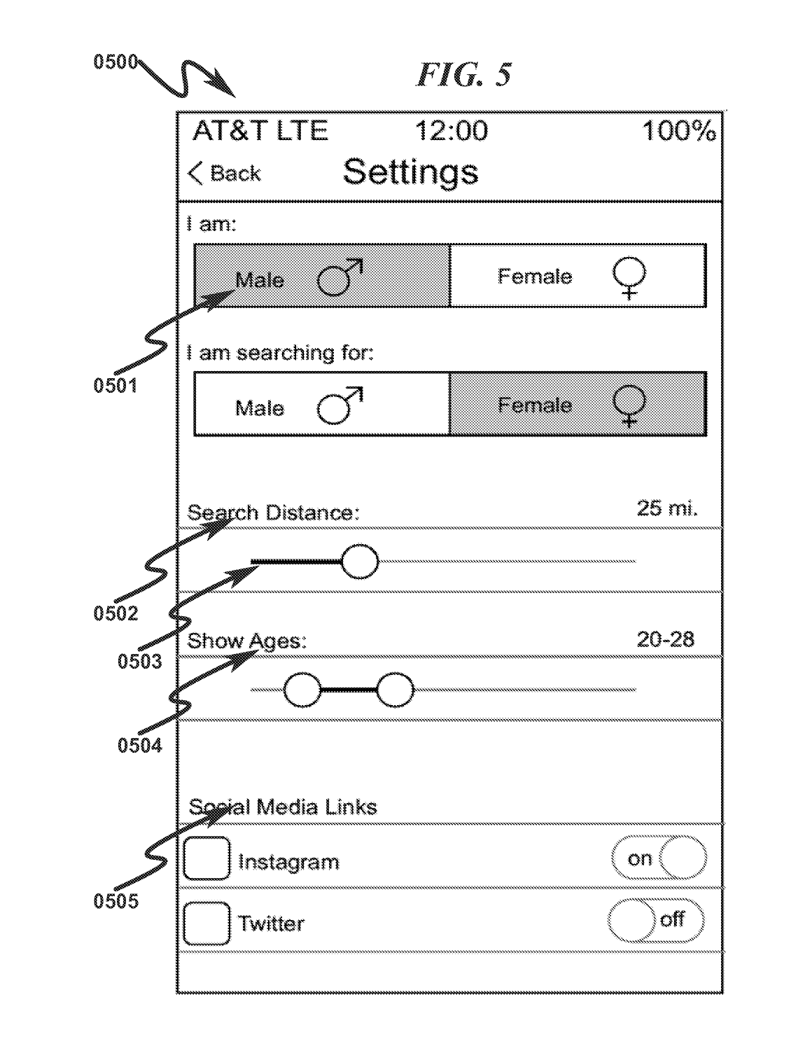

As illustrated below in FIG. 5 (0500), an exemplary settings menu may include options to set search criteria such as gender, distance, age, and social media links. A user may download an activity-based social networking application and display a home screen upon installing the application. The home screen may have a menu to navigate to a settings screen as shown in FIG. 5 (0500). The setting menu may include the user gender information (0501) and a preference for a gender search (0502). For example male user may prefer to search for a male user to perform a weight training activity in a gym. According to an exemplary embodiment, another search preference is a search distance (0502) criteria. The search distance (0502) is taken as the limit to search for user within a certain distance as determined by a GPS system. The distance (0502) may be specified in terms of a sliding scale (0503). It should be noted that a sliding scale for setting search distance is shown for illustration purposes only, any other entry mechanism such as drop down menu, digital tab, and/or circular indicator may be used. An example of search distance is 10 miles radius. Yet another search preference may include age (0504) to indicate activity networking within a certain age range. For example, college users may prefer to network with other college users within a certain age.

### An Exemplary Embodiment Application Activity Menu (0600-0800)

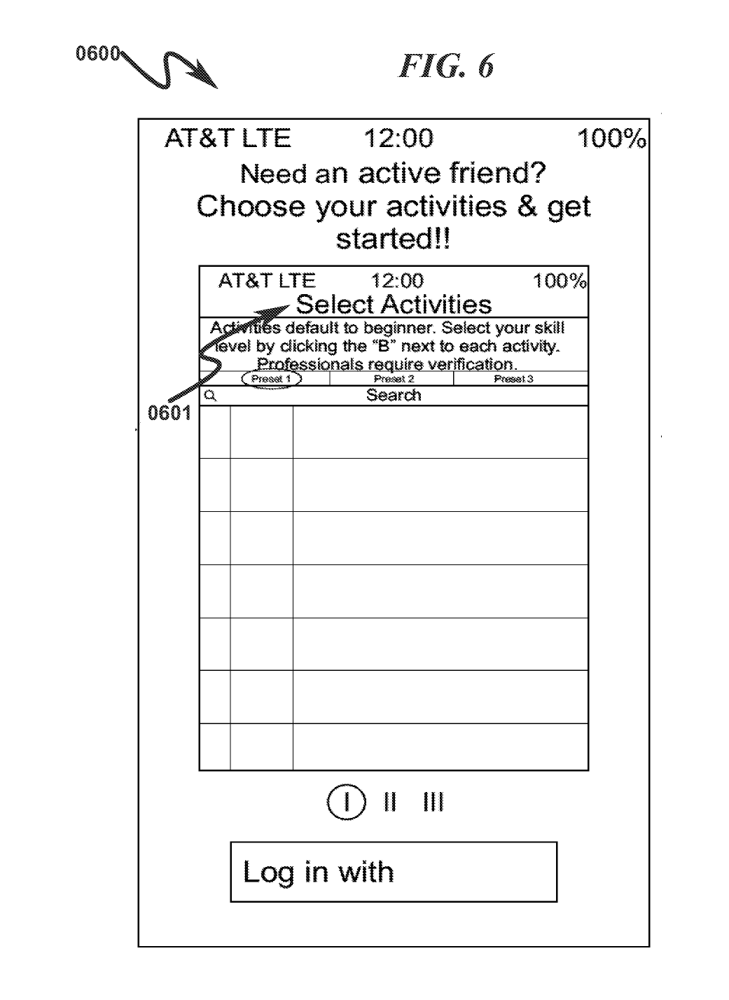

As illustrated below in FIG. 6 (0600), an exemplary settings menu in the activity networking application may include options to set search criteria such as an activity selected from a list shown in Table 1.0. The user may select plural activities at one time with the application. The user may also indicate a proficiency level such as beginner level (“B”), intermediate level (“I”) or professional level (“X”). The professional level may be verified by a recognized third party organization. For example USIA is an organization that certifies user tennis proficiency as amateur or professional and assign ratings. According to an exemplary embodiment, activity networking application enables users to search for matching users based on an activity level and proficiency.

TABLE 1.0
List of Sports/Activities

| | |
|---|---|
| 1 | Archery |
| 2 | Backpacking |
| 3 | Baseball |
| 4 | Basketball |
| 5 | BMX |
| 6 | Body-boarding |
| 7 | Bowling |
| 8 | Camping |
| 9 | Canoeing |
| 10 | Canyoning |
| 11 | Cliff-jumping |
| 12 | Cricket |
| 13 | Cycling (road) |
| 14 | Dance |
| 15 | Disk golf |
| 16 | Equestrian |
| 17 | Fencing |
| 18 | Fishing |
| 19 | Football |
| 20 | Free-Boarding |
| 21 | Fun Runs |
| 22 | Golf |
| 23 | Gymnastics |
| 24 | Hiking |
| 25 | Hockey |
| 26 | Ice-skating |
| 27 | Inline Skating |
| 28 | Kayak |
| 29 | Kickball |
| 30 | Kitesurf |
| 31 | Lacrosse |
| 32 | Long-Boarding |
| 33 | Marathon |
| 34 | Motocross |
| 35 | Motorcycle (Cruiser) |
| 36 | Motorcycle (Sport) |
| 37 | Mountain Biking (MTB) |
| 38 | Mud Runs |
| 39 | Paddle boarding |
| 40 | Paintball |
| 41 | Pilates |
| 42 | Polo |
| 43 | Racquetball |
| 44 | Rafting |
| 45 | Rock climbing (indoor) |
| 46 | Rock climbing (outdoor) |
| 47 | Rodeo |
| 48 | Rugby |
| 49 | Running/Jogging |
| 50 | Sailing |
| 51 | Scuba Diving |
| 52 | Skateboarding |
| 53 | Skydiving |
| 54 | Snorkeling |
| 55 | Snowboarding |
| 56 | Snowmobiling |
| 57 | Snow Skiing |
| 58 | Soccer |
| 59 | Softball |
| 60 | Surfing |
| 61 | Swimming |
| 62 | Tennis |
| 63 | Track & Field |
| 64 | Volleyball |
| 65 | Wakeboarding |
| 66 | Water Polo |
| 67 | Water Skiing |
| 68 | Weight-lifting |
| 69 | Windsurfing |
| 70 | Yoga |
| 71 | Zumba |

### An Exemplary Embodiment Networking Matching Score (NMS)

According to an exemplary embodiment, the activity networking application may use an algorithm to search for users within a geographic distance meeting the specific activity, activity proficiency, age, and gender. The algorithm may compute a networking matching score (NMS) and prioritize the results of the search in a descending order of the matching score. A user may further input weightage to individual factors for calculating the matching score. For example, a user might be constrained by distance and may input a higher weighting versus the activity proficiency level or age. The algorithm considers the weightage of the individual components and computes a matching score as shown below.

Networking Matching Score (NMS)=Function (Distance, Age, Gender, Activity, Proficiency, Weighting factors).

NMS=function(X₁D₁,X₂D₂,X₃D₃,X₄D₄)
Where X₁, X₂, X₃, X₄ are the weightage factors and
X₂, X₃, X₄ are the search factors such as Distance, Age, Gender, Activity, Proficiency, Weighting factors.

TABLE 2.0
Networking Matching Score (NMS)

| | | | | | | Networking |
|---|---|---|---|---|---|---|
| | | | | Activity | | Matching |
| User | Distance | Age | Gender | Type | Proficiency | Score |
| User1 | 5 | 21 | M | Yes | B | 94 |
| User2 | 15 | 46 | M | Yes | B | 82 |
| User3 | 7 | 76 | F | Yes | I | 64 |
| User4 | 8 | 23 | M | Yes | B | 98 |
| User5 | 9 | 34 | F | Yes | I | 82 |
| User6 | 4 | 42 | F | Yes | I | 86 |
| User7 | 2 | 26 | M | Yes | X | 99 |
| User8 | 10 | 34 | F | Yes | B | 84 |

### An Exemplary Embodiment Networking Activity Search Display (0900-1100)

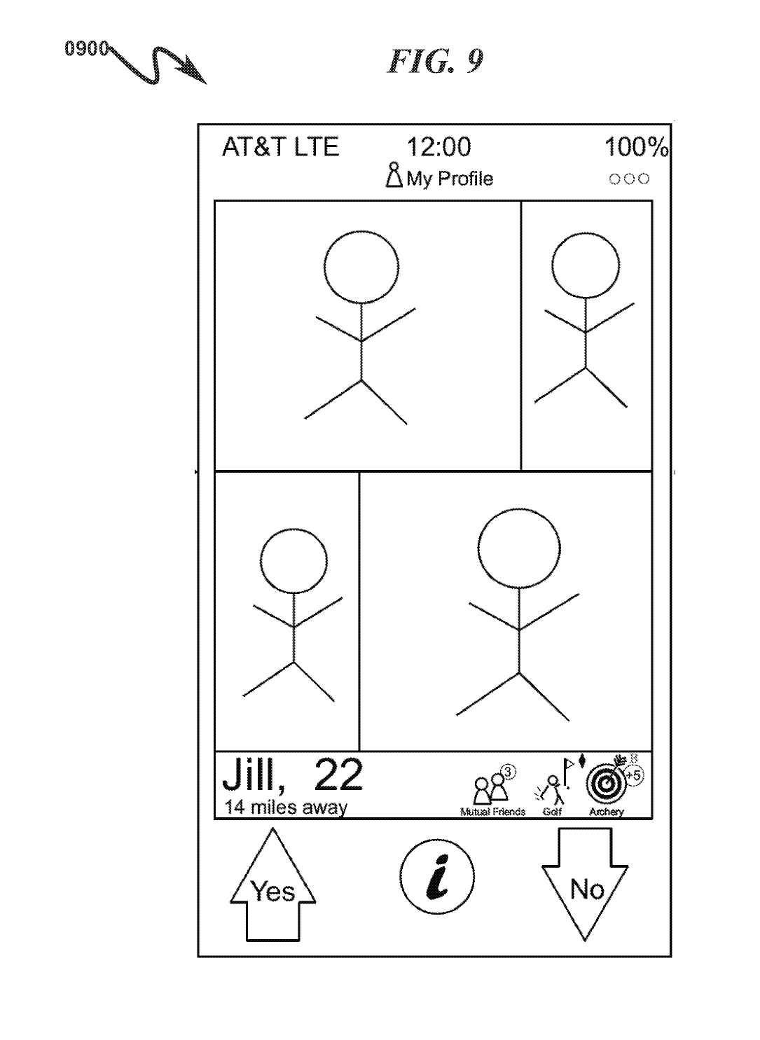

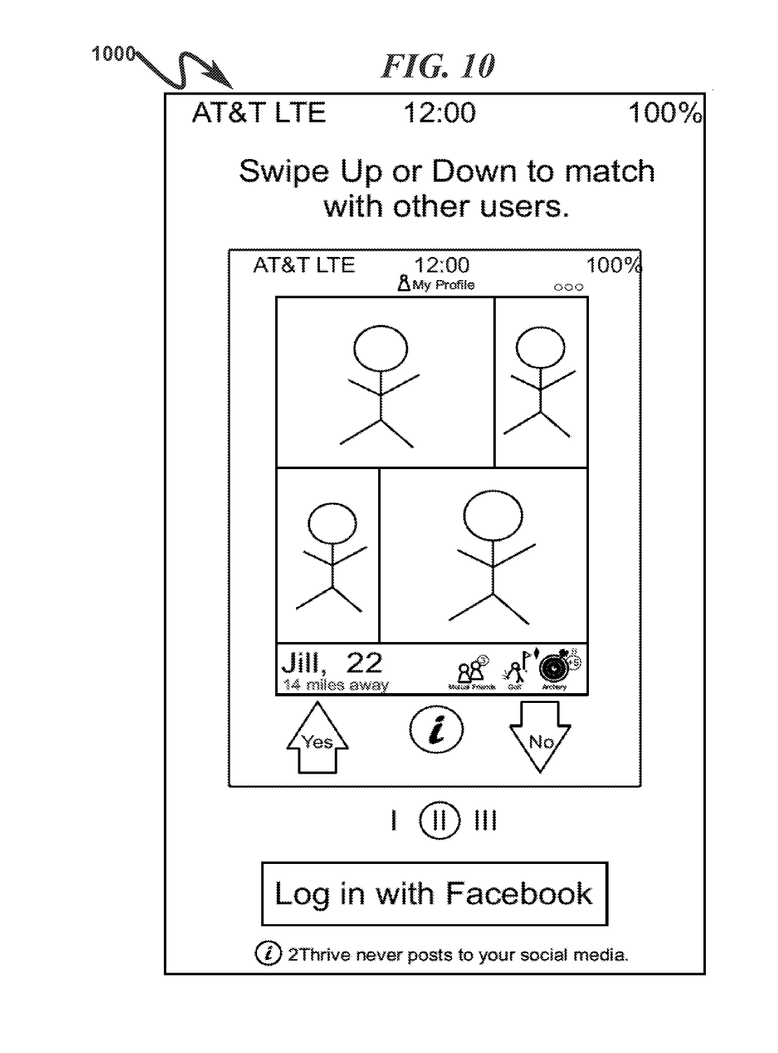

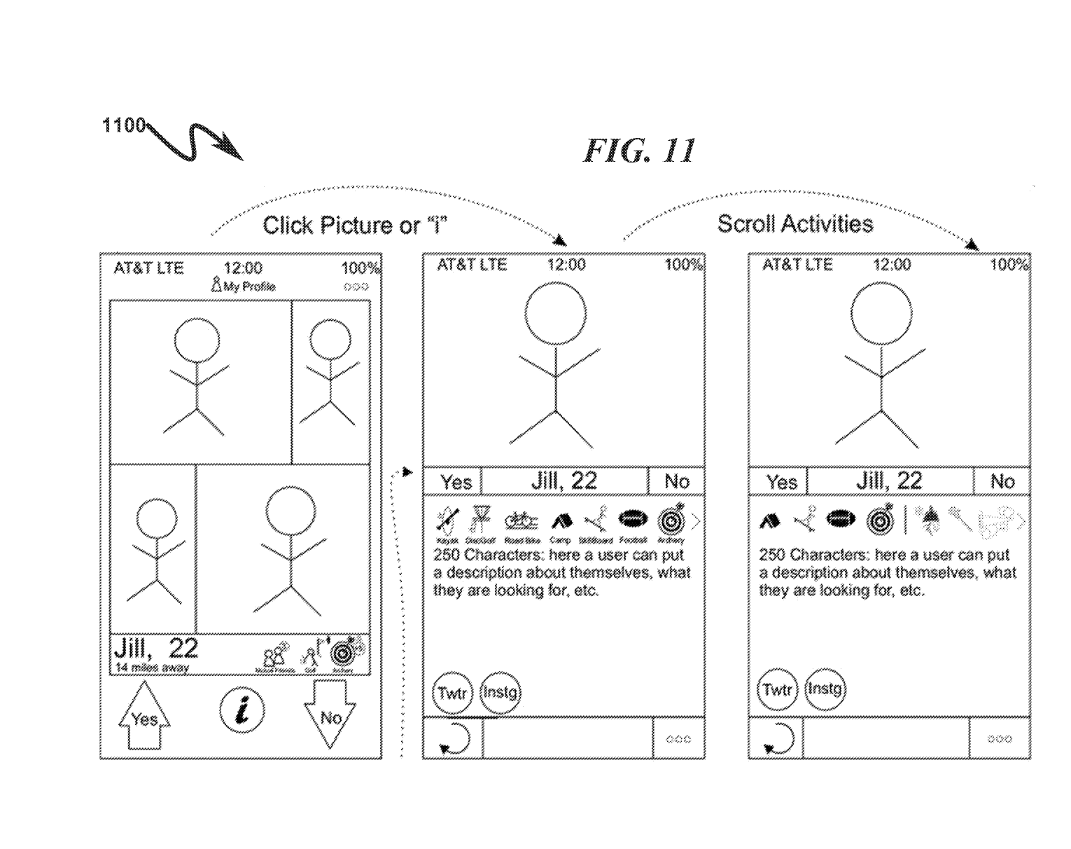

As illustrated in FIG. 9 (0900), FIG. 10. (1000) and FIG. 11 (1100), search results from the exemplary activity networking application may be displayed 4 at a time on the mobile computing devices. The results may be displayed in the order of networking matching score computed by the algorithm. It should be noted that the touch screen display showing 4 matched user profiles is for illustration purposes only and may not be construed as a limitation. The user may select the displayed results one at a time or reject by swiping away gesture. It should be noted that any swiping gesture may be customized to accept or reject a matched user profile. For example, a gesture swiping up a screen may be an acceptance, while swiping down may be a rejection. Similarly, a user may gesture swipe left of a screen to be an acceptance, while gesture swiping right may be a rejection. According to an exemplary embodiment, a user may also delete or block a user from showing up in the matched results based on prior experience or history with the matched user. The user may maintain a list of blocked users in the application so that they do not show up in future search results for system-matched user profiles. The system may also maintain a database of preferred user-profiles that may be selected when the user performs a search based on the user preferences. The system may also perform a search of a database of other users and retrieve user profiles that match the user preferences of the user as system-matched user profiles. The database may be maintained in the on the mobile computing device or on a remote server maintained by the system.

### An Exemplary Embodiment Activity Networking Invitation Method (1200)

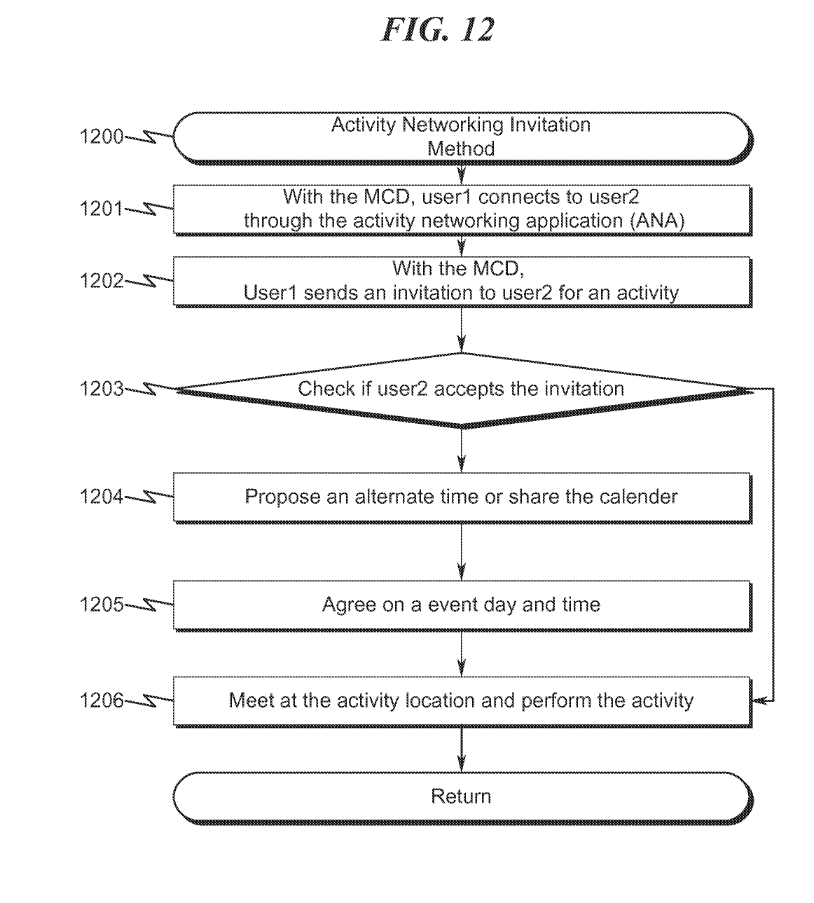

As generally illustrated in the flow chart of FIG. 12 (1200), the exemplary activity networking invitation method may be described in terms of the following steps:
(1) opening the activity networking application and connecting with an user (1201);
(2) sending an invitation for an event at a location to the connected user with the application (1202);
(3) checking for acceptance from said connected user, if so, proceeding to step (1206) (1203);
(4) proposing an alternate time and day or sharing calendars for the event (1204);
(5) agreeing on a time and day for the event (1205); and
(6) meeting and performing the event on the event day and time at the location (1206).

One skilled in the art will recognize that these method steps may be augmented or rearranged without limiting the teachings of the present invention. This general method summary may be augmented by the various elements described herein to produce a wide variety of exemplary embodiments.

### An Exemplary Embodiment Activity Networking Messaging Method (1300-1500)

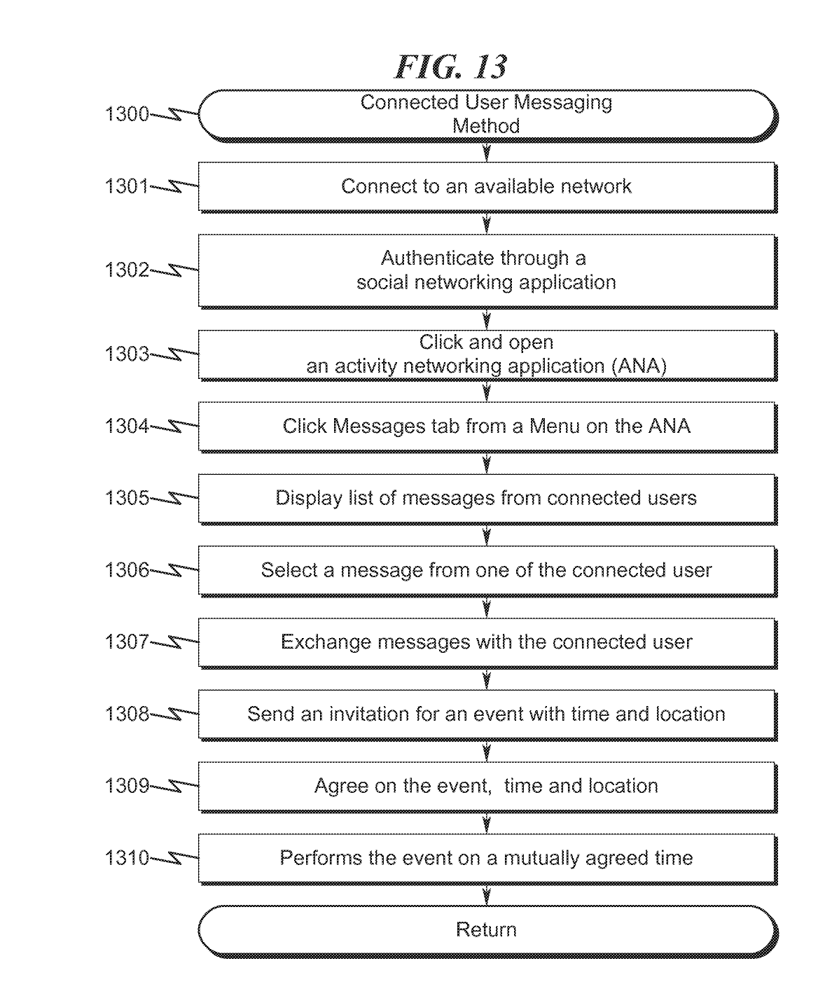

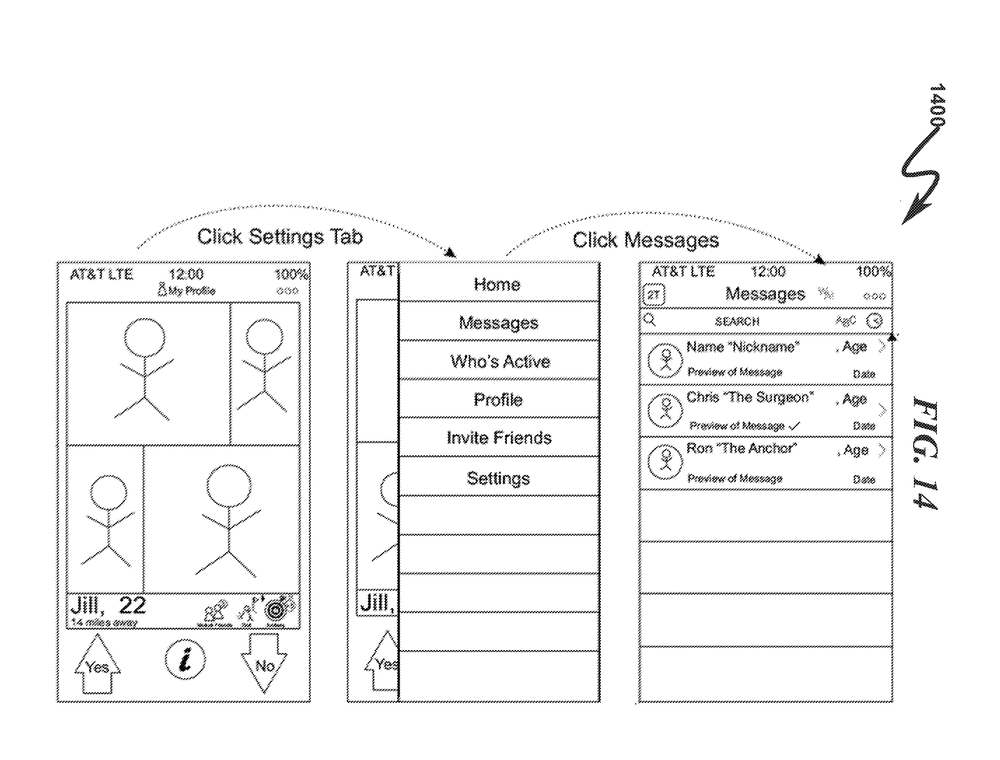

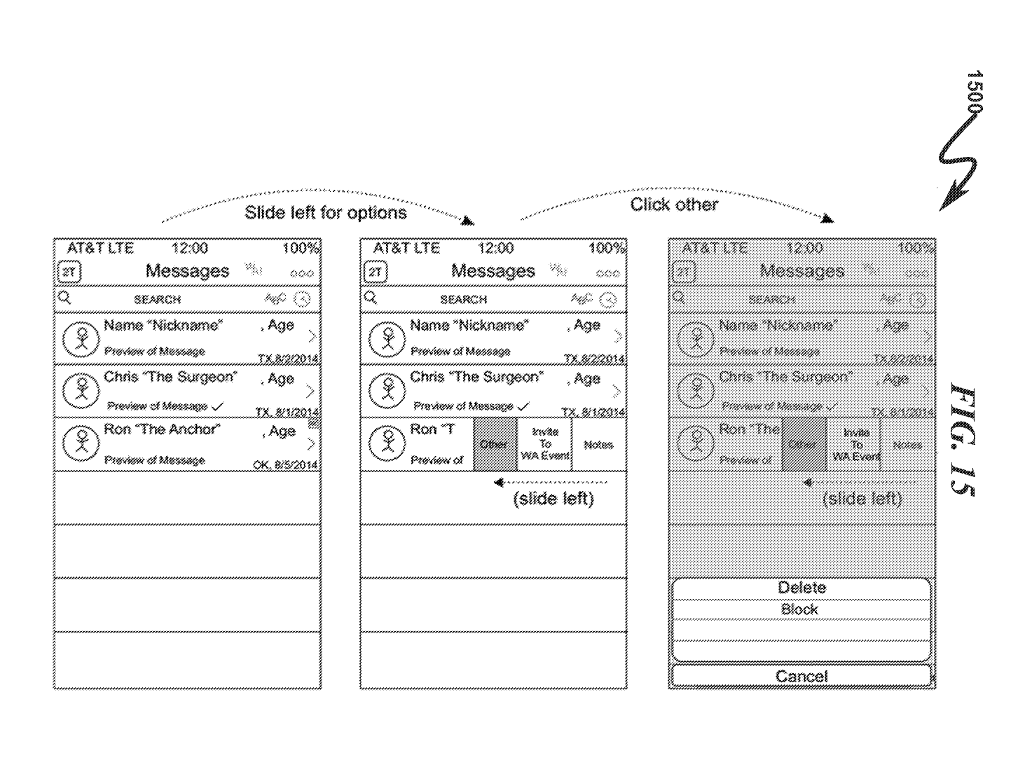

As generally illustrated in the flow chart of FIG. 13 (1300), an exemplary activity networking messaging method may be generally described in terms of the following steps:
(1) connecting to a network (1301);
(2) authenticating through a social networking application such as Facebook™ or Twitter™ (1302);
   It should be noted that even though Facebook™ or Twitter™ are mentioned as social networking applications, it should be construed as limitation. Other social networking applications capable of authenticating a user may be used.
(3) opening the activity-based social networking application (1303);
(4) clicking on messages tab from a menu in the application as illustrated in FIG. 14 (1400) (1304);
(5) displaying a list of messages with the application as illustrated in FIG. 15 (1500) (1305);
(6) selecting a connected user message from the list (1306);
(7) exchanging messages with the connected user (1307);
(8) sending an invitation for an event at a location to the connected user with the application (1308);
(9) agreeing on a time and day for the event (1309); and
(10) meeting and performing the event on the event day and time at the location (1310).
One skilled in the art will recognize that these method steps may be augmented or rearranged without limiting the teachings of the present invention. This general method summary may be augmented by the various elements described herein to produce a wide variety of exemplary embodiments consistent with this overall design description.

### An Exemplary Embodiment Active Group Networking Method (1600)

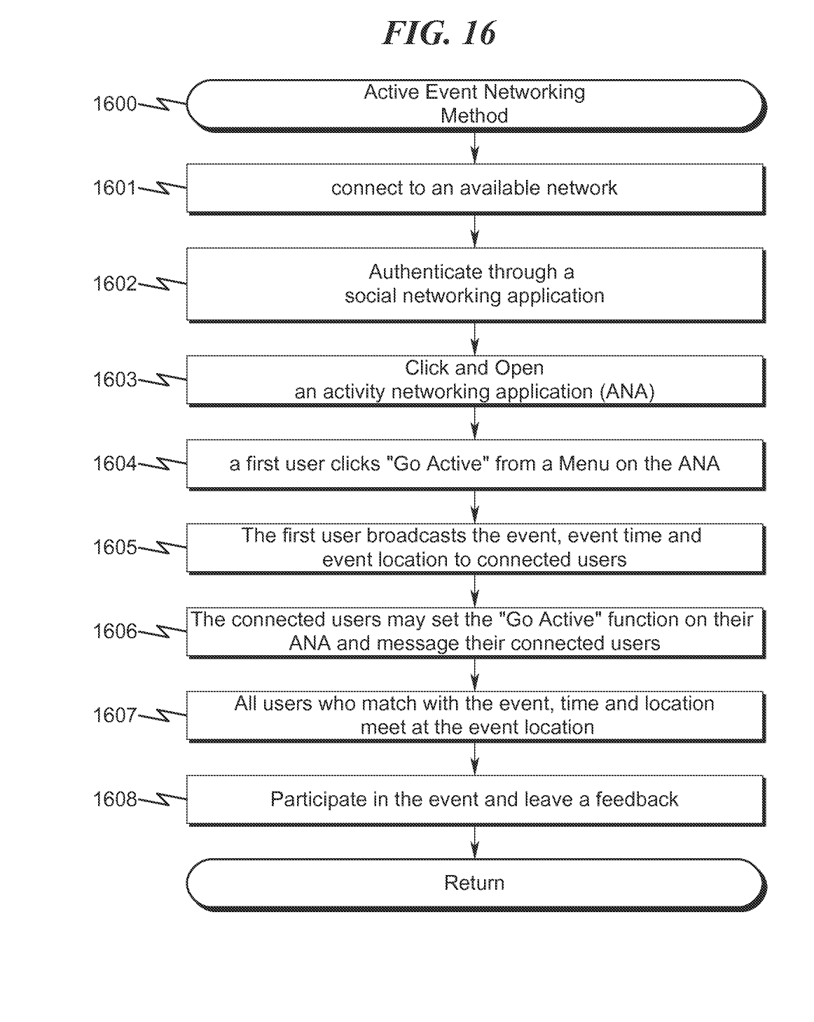

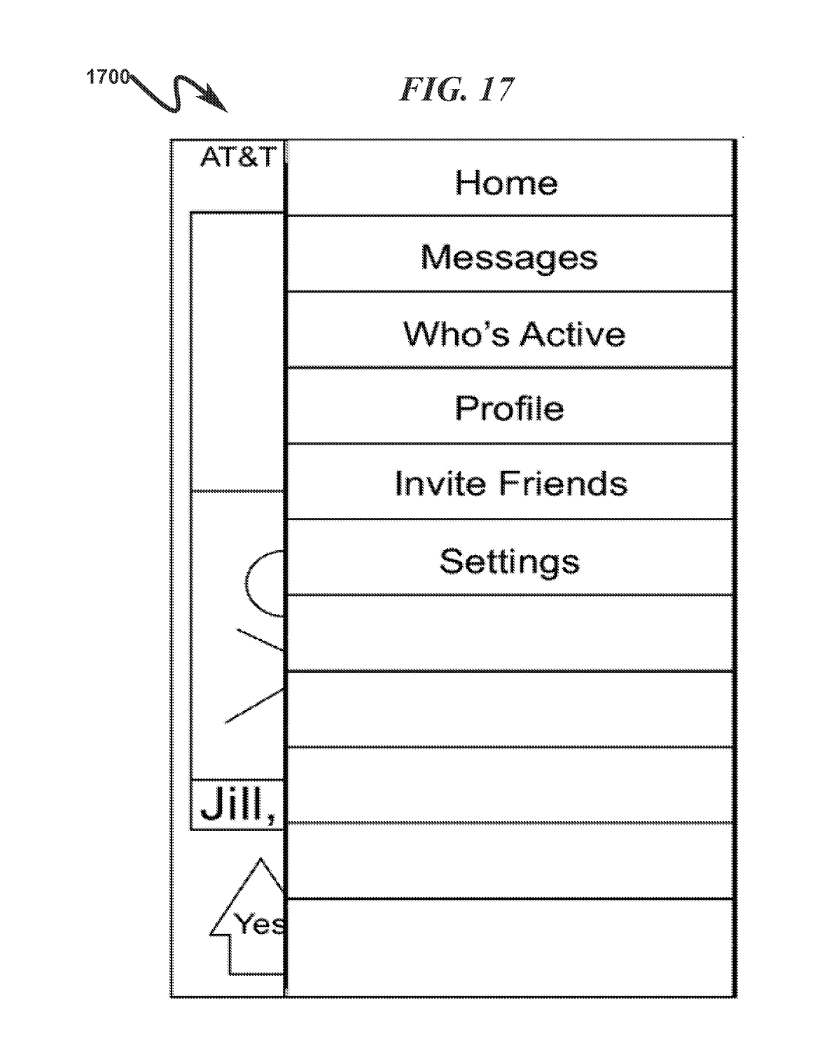

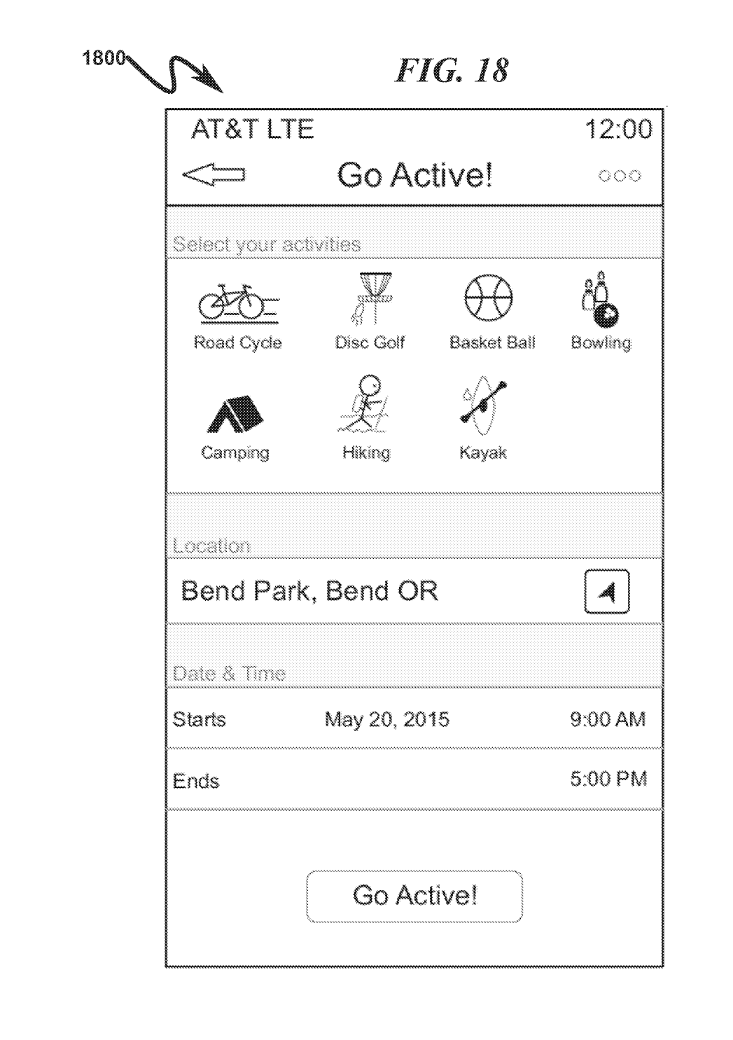

As generally illustrated in the flow chart of FIG. 16 (1600), an exemplary active group networking method may be generally described in terms of the following steps:
(1) connecting to a network (1601);
(2) authenticating through a social networking application such as Facebook and Twitter (1602);
(3) opening the activity networking application as illustrated in FIG. 17 (1700) (1603);
(4) with a first user, clicking on GO ACTIVE tab from a menu in the application as illustrated in FIG. 18 (1800) (1604);
(5) with the first user, broadcasting an event, time, day and location to connected users (1605);
(6) with the connected users, broadcasting the event, the time, the day and the location to their connected users (1606);
(7) with the application, the first user, the connected users and their connected users matching the event, the time, the day and the location (1607); and
(8) meeting and performing the event on the event day and time at the location and leaving a feedback for future events (1608).

### An Exemplary Embodiment Activity Dating Method (1900)

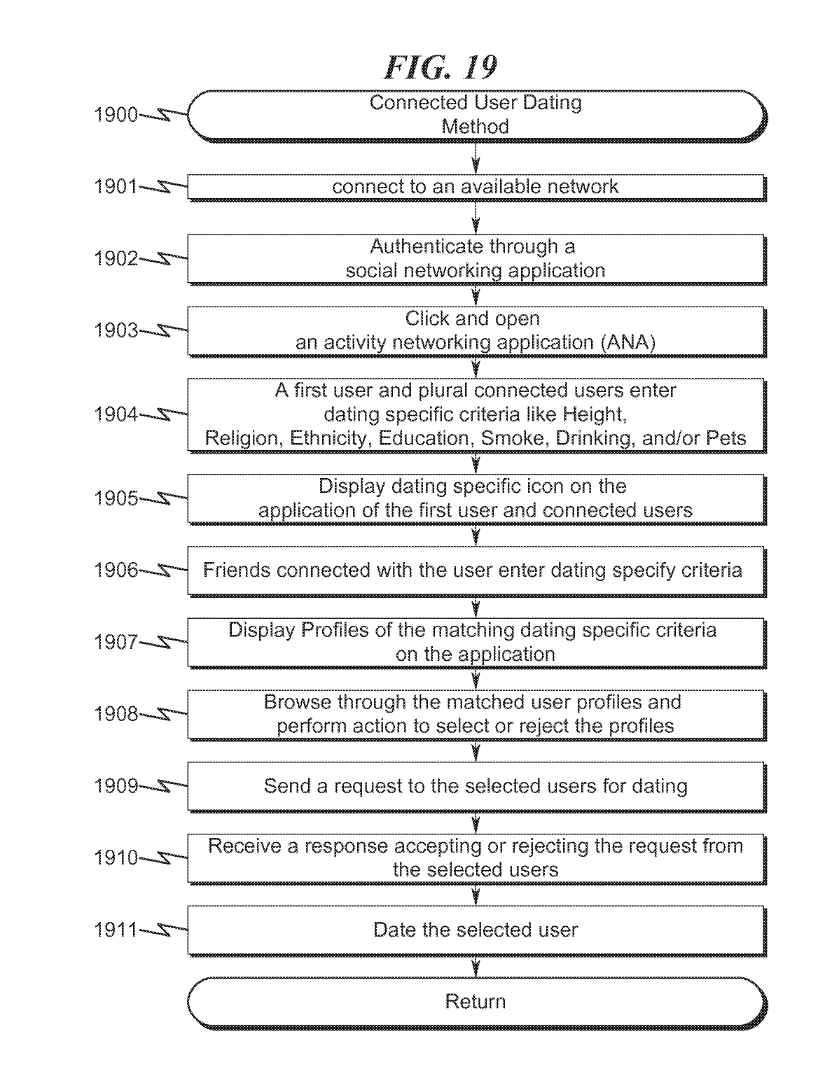

As generally illustrated in the flow chart of FIG. 19 (1900), an exemplary active dating method may be generally described in terms of the following steps:
(1) connecting to a network (1901);
(2) authenticating through a social networking application such as Facebook and Twitter (1902);
(3) opening the activity-based social networking application (1903);
(4) with the activity networking application, a first user and plural connected users entering dating specific criteria (1904); dating specific criteria may include but is not limited to the following criteria.
   Height: feet/inches or cm; can choose either measure. If a user puts his/her height in metric and another puts in standard, it the application automatically converts the height so that they can match. Since the application doesn't convert exactly a small range may be tolerated for them to match up.
   Religion: Agnostic, Buddhist, Christian, Catholic, Jewish, Muslim, Hindu, Other.
   Ethnicity: White/Caucasian, Black/African, Latino/Hispanic, Asian, Indian, Middle Eastern, Mixed/Other.
   Education: No Degree, High School, Some College, Bachelor's Degree, Master's Degree, Doctorate Degree.
   Smoke: No, Socially, Regularly.
   Drinking preferences: No, Socially, Regularly.
   Dogs, cats, or both.
(5) displaying a dating specific icon on the first user activity networking application and the plural connected user activity networking applications (1905);
(6) searching for matching profiles with the application (1906);
(7) displaying matching profiles based on the dating specific criteria (1907);
(8) browsing through the matched user profiles (system-matched users) and perform action to select or reject the profiles (1908);
(9) sending a request for dating to the accepted matched user (1909);
(10) receiving an acceptance response from the accepted matched user (1910); and
(11) dating the accepted matched user (1911).

One skilled in the art will recognize that these method steps may be augmented or rearranged without limiting the teachings of the present invention. This general method summary may be augmented by the various elements described herein to produce a wide variety of exemplary embodiments consistent with this overall design description.

### An Exemplary Embodiment Snap Reporting Method (2000)

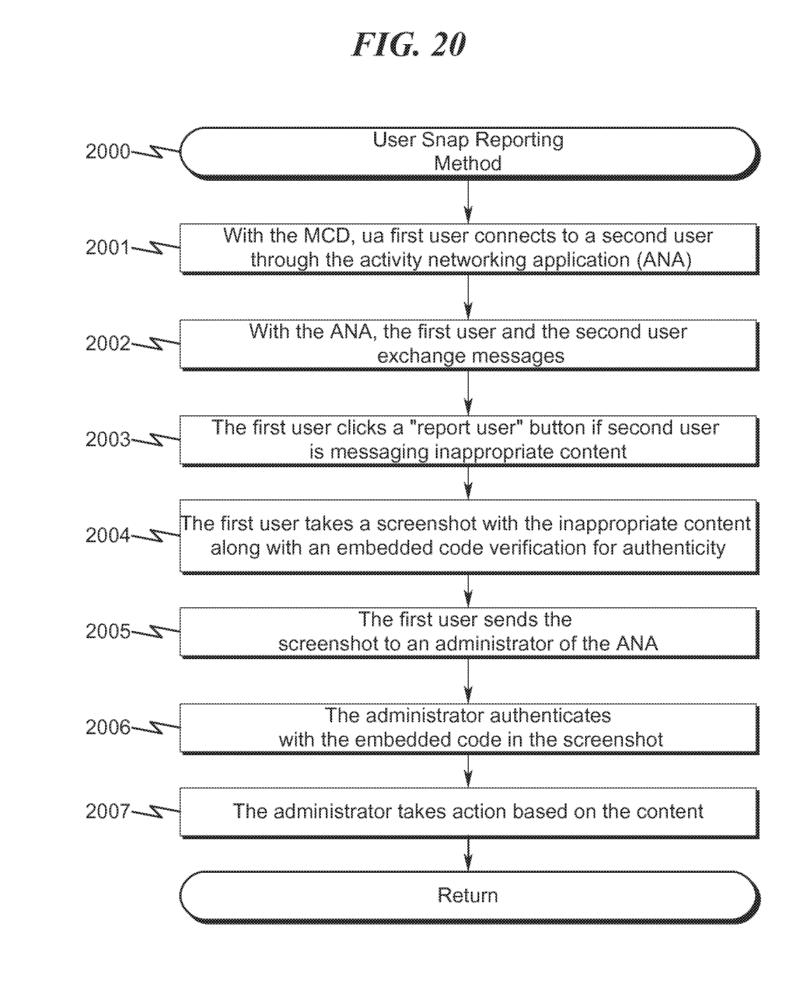

As generally illustrated in the flow chart of FIG. 20 (2000), an exemplary snap reporting method may be generally described in terms of the following steps:
(1) with the activity-based social networking application, connecting a first user connects with a second user (2001);
(2) exchanging messages between the first user and the second user (2002);
(3) clicking a user report button if a user messages inappropriate content (2003);
(4) taking a screenshot with an embedded verification code of the inappropriate content (2004); the user may take a screenshot within the application that will automatically add a coded verification to the screenshot where an administrator can click on the picture and go straight to the content;
   For example: Jill takes a screenshot of an inappropriate message from John. After she sends in the screenshot, an administrator can click on the screenshot and it will direct to that part of the message where the content lies that need to be reviewed;
(5) sending the screenshot with the embedded verification code to an administrator (2005);
(6) authenticating said screenshot with said embedded verification code (2006); and
(7) acting based on said inappropriate content (2007). The user may report based on content, pictures of the user, and spam.

One skilled in the art will recognize that these method steps may be augmented or rearranged without limiting the teachings of the present invention. This general method summary may be augmented by the various elements described herein to produce a wide variety of exemplary embodiments consistent with this overall design description.

### System Summary

The present exemplary embodiment system anticipates a wide variety of variations in the basic theme of activity networking, but can be generalized as a mobile social activity networking system configured for facilitating event planning and coordination of activities between system-matched users of the system. The system is configured for use on mobile computing devices operatively configured with global positioning system capability. The system is further configured to enable a system user to input user preferences via a downloaded networking application. The user preferences may include preferred activities the user wants to engage in, the preferred geographic range of proximity to the user of other users the user wants to communicate with; and communicate with other users of the system conforming to the user's input user preferences to facilitate organizing a time and place to meet for a planned activity or event that includes at least one of the input user preferences. The system uses the input user preferences of users and the users location based on the global positioning system indication of the users location to match user's with each other to create system-matched users.

Another present exemplary embodiment system anticipates a wide variety of variations in the basic theme of activity networking, but can be generalized as a mobile social activity networking system for facilitating event planning and coordination of activities between system-matched users of the system. The system is configured for use by a plurality of users that each have a mobile computing device operatively configured with global positioning system capability. The system is configured to enable a user to use the mobile computing device to download an activity networking application into the mobile computing device, and the system authenticates the download and authorizes the user, based on user data input via the downloaded social networking application. The system further receives user input preferences including demographic data defining other users the user wants to interact with, preferred activities the user wants to engage in, the preferred geographic range of proximity to the user of other users the user wants to communicate with. The system selects user profiles that match the user input preferences of the user and presents them as system-matched user profiles and enable the user to view and browse through the system-matched user profiles on the user's mobile computing device, perform an action to accept or reject a user profile, send a request to an accepted system-matched user and receive a response from the accepted system-matched user.

Yet another present exemplary embodiment system anticipates a wide variety of variations in the basic theme of activity networking, but can be generalized as a mobile social activity networking system configured for facilitating event planning and coordination of activities between system-matched users of the system. The system is configured for use by a plurality of users that each have a mobile computing device operatively configured with global positioning system capability, with touch-activated graphic user interface, and with communications capability through telephony or wifi, or both. The system is further configured to:

enable a user to use the mobile computing device and download an activity networking application into the mobile computing device, and the system authenticates the download and authorizes the user, based on user data input via the downloaded activity networking application;

receive user input preferences, including demographic data defining other users the user wants to interact with, preferred activities the user wants to engage in, the preferred geographic range of proximity to the user of other users the user wants to communicate with;

identify as system-matched user profiles, user profiles of others in a database that conform to the user's input preferences; and

enable the user to:
browse through the system-matched user profiles on the graphic user interface of the user's mobile computing device;
perform an action to accept or reject a browsed user profile;
send a communication to an accepted browsed user profile; and

receive a responsive communication from the accepted user profile.

This summary of exemplary systems may be augmented by the various elements described herein to produce a wide variety of invention embodiments consistent with this overall design description.

### Method Summary

An exemplary embodiment of the methods anticipates a wide variety of variations in the basic theme of implementation. The system comprises users using mobile computing devices (MCDs) equipped with global positioning devices. The exemplary method can be generalized as a mobile social activity networking method wherein some of the method steps are performed by the system and other steps are enabled by the system to be carried out by the users, using the mobile social activity application on their mobile devices. The method comprises using a system that is configured such that it enables the users to carry out the steps of:
(1) with the mobile computing device, connecting to a network;
(2) loading an activity networking application into the mobile computing device;
(3) authenticating through a social networking application;
(4) inputting user preferences, such as choosing activities indicating proficiency level and selecting range of distance to search for potential other users that match;
(5) performing searches with the application and retrieve “matching user profiles” on the mobile computing device in real-time (since users may be travelling and GPS location can vary);
(6) browsing through the matching user profiles (system-matched users) and performing an action to accept or reject a user profile;
(7) sending a request with the application to a user with the system-matched profile;
(8) receiving a response from the user with the matched profile; and
(9) connecting with the user of the system-matched profile.

In the method, the system creates the matches between the user profiles (“system-matched user profiles”) based on the input preferences of the users.

This general method summary may be augmented by the various elements described herein to produce a wide variety of exemplary embodiments consistent with this overall design description.

### System/Method Variations

As explained, the examples presented above do not limit the scope of the inventions.

In an exemplary embodiment, when the system user travels to a new location, the system detects the user's location using the global positioning system capability of the mobile computing device of the user, and the system automatically uses the user's input geographic range (distance from other prospective users for planned events/activity) preferences to allow the user to communicate with other users at the new location (which is his/her travel destination, if he/she has arrived) that conform to the user′ input user preferences.

An exemplary embodiment wherein the system is further configured to enable a system user to:
download an activity-based social networking application onto a mobile computing device, and register as an authenticated user of the system;
wherein the user preferences further include demographic data defining other users that the user wants to interact with.

Optionally, one of the preferred activities is dating.

Optionally, one of the preferred activities is playing a sport.

Optionally, one of the preferred activities is an event initiated by an administrator of the social networking system.

Optionally, one of the preferred activities is an event initiated by at least one of the system-matched users.

Optionally, at least one of the preferred activities has a proficiency level; and the system uses proficiency level to determine the system-match users.

Optionally, the system-matched users are determined by the social networking application based on a network matching score; the network matching score is computed from the demographic data, the geographical range, the preferred activity and a proficiency level.

Optionally, the system further enables the user to accept or reject system-matched users with a gesture on the touch screen of the mobile computing device.

Optionally, the system performs a search of a database of other users and retrieves user profiles of others that match the user preferences of the user as system-matched user profiles.

Optionally, and alternatively, the system computes a network matching score based on the user preferences of the user to determine system-matched user profiles.

Optionally, system further enables the user to accept or reject a system-matched user profile with a gesture on the touch screen of the mobile computing device.

Optionally, the system further enables the user to accept or reject a system-matched user profile with a keyboard on the mobile computing device.

Optionally, the system further enables the user to reject a system-matched user profile based on a blocked list created by the user of other users that he/she does not want to communicate with; the blocked list maintained on the activity application of his/her mobile device, and amendable by the creator-user.

Optionally, the system further enables the user to automatically accept a system-matched user profile based on a preferred list; the preferred list created, maintained and amendable by the user on the activity application of his/her mobile device.

Optionally, the system further enables the user to send an invitation to an accepted system-matched user (i.e. a connected user) for an event at a location; and upon acceptance from the connected user, the user and the connected user agree to the time and place of the event.

Optionally, the system further enables the user to send an invitation to an accepted system-matched user (connected user) for an event at a location; and upon rejection from the connected user, the system proposes an alternate time and day and shares a calendar for the event; and upon acceptance from the connected user, the user and the connected user agree and to perform the event at the time and place.

Optionally, the system further enables messaging between a user and at least one of the system-matched users, wherein the system displays a list of messages when the user clicks on a “messages” tab from a menu in the activity application; and enables the user to select a connected user message from the list; exchange messages with the connected user; send an invitation for an event at a location to the connected user; agree on a time and day for the event; and arrange to meet on the day and the time at the location.

Optionally, the system is further configured to facilitate reporting by the user during exchanging of messages. The system enables the user to click a “user report button” on the social activity networking application, when another user sends messages to him/her with “inappropriate content.” The user may take a screenshot with an embedded verification code of the inappropriate content; and send the screenshot to an administrator. When the system authenticates the screenshot with the embedded verification code, the administrator can determine what action to take based on the asserted inappropriate content.

One skilled in the art will recognize that other embodiments are possible based on combinations of elements taught within the above invention description.

### CONCLUSION

Mobile social activity networking systems and methods with geographical vicinity features based on the use of GPS has been disclosed. The system/methods include mobile computing devices (MCDs) communicating over a network. The MCDs are enabled to keep track of their geographic location through a global positioning system (GPS). Users download an activity network application (ANA) from a mobile application server (MAS) through a mobile web server (MWS). With the ANA, users choose a distance and activity criteria indicating proficiency. The application searches for users within the distance with the GPS and matches users with the activity criteria. The user can perform an action to accept the matched profile. The user sends an invitation to connect with the matched user and upon acceptance, both the users are connected. The connected users can message each other or share calendar to plan activities. Connected users and their connections with a matching interest join and participate in the event.

Although various embodiments of the present exemplary embodiment have been illustrated in the accompanying drawings and described in the foregoing Detailed Description, it will be understood that the exemplary embodiment is not limited to the embodiments disclosed, but is capable of numerous rearrangements, modifications, and substitutions without departing from the spirit of the exemplary embodiment as set forth and defined by the following claims.

1. A mobile social activity networking system configured for facilitating event planning and coordination of activities between system-matched users of the system, the system configured for use on mobile computing devices comprising global positioning system receivers, the system configured to enable a system user to:
input user preferences on a mobile computing device via a downloaded social networking application on the mobile computing device, the user preferences including preferred activities of the user, the preferred geographic range of proximity to the user of other users that the user wants to communicate with; and
communicate with other users of the system conforming to the user's input user preferences to facilitate organizing a time and place to meet for a planned activity or event that includes at least one of the input user preferences;
wherein the system retrieves GPS coordinates of the mobile computing devices using the global positioning system receivers, the system calculates relative locations of the mobile computing devices using the retrieved GPS coordinates, the system uses data including the user preferences of the user, the user preferences of the other users of the system and the calculated relative locations of the mobile devices of others users, to match users with each other to create system-matched users.

2. The mobile social activity networking system of claim 1 wherein, when the system user travels to a new location, the system detects the user's location using the global positioning system receiver of the mobile computing device of the user, and the system automatically uses the user's input geographic preferences to allow the user to communicate with other users at the new location that conform to the user's input user preferences.

3. The mobile social activity networking system of claim 1 wherein the system is further configured to enable a system user to:
download the social networking application onto a mobile computing device; and
register as an authenticated user of the social activity networking system.

4. The mobile social activity networking system of claim 1 wherein the user preferences further include demographic data defining other users that the user wants to interact with.

5. The mobile social activity networking system of claim 1 wherein one of the preferred activities is dating.

6. The mobile social activity networking system of claim 1 wherein one of the preferred activities is playing a sport.

7. The mobile social activity networking system of claim 1 wherein one of the preferred activities is an event initiated by an administrator of the social networking system.

8. The mobile social activity networking system of claim 1 wherein one of the preferred activities is an event initiated by at least one of the system-matched users.

9. The mobile social activity networking system of claim 1 wherein at least one of the preferred activities has a proficiency level; and the system uses proficiency level to determine the system-match users.

10. The mobile social activity networking system of claim 4 wherein said system-matched users are determined by the social networking application based on a network matching score; the network matching score is computed from the demographic data, the geographical range, the preferred activity and a proficiency level.

11. The mobile social activity networking system of claim 1 wherein the system further enables the user to accept or reject system-matched users with a touch gesture on a graphic user interface of the mobile computing device.

12. A mobile social activity networking system configured for facilitating event planning and coordination of activities between system-matched users of the system, the system configured for use by a plurality of users that each have a mobile computing device comprising a global positioning system receiver, wherein the system is configured to:
enable a user to use the mobile computing device to download a social activity networking application into the mobile computing device; and
wherein the system authenticates the download and authorizes the user, based on user data input via the social networking application;
receives user input preferences including demographic data defining other users the user wants to interact with, preferred activities the user wants to engage in, the preferred geographic range of proximity to the user of other users the user wants to communicate with;
retrieves GPS coordinates of the mobile computing devices using the global positioning system receivers;
calculates relative locations of the plurality of users through the mobile computing device that each of the plurality of users has, using the retrieved GPS coordinates;
selects user profiles that match the user input preferences of the user, wherein the user profiles comprise the relative locations of the plurality of users, and presents the user profiles as system-matched user profiles; and
enables the user to:
view and browse through the system-matched user profiles on the user's mobile computing device;
perform an action to accept or reject a system-matched user profile;
send a communication to an accepted system-matched user via the social activity networking application; and
receive a responsive communication from the accepted system-matched user.

13. The mobile social activity networking system of claim 12 wherein the system performs a search of a database of other users and retrieves user profiles that match the user preferences of the user to create system-matched user profiles.

14. The mobile social activity networking system of claim 12 wherein the system computes a network matching score based on the user preferences of the user to determine system-matched user profiles.

15. The mobile social activity networking system of claim 12 wherein the system further enables the user to accept or reject a system-matched user profile with a gesture on a touch screen of the mobile computing device.

16. The mobile social activity networking system of claim 12 wherein the system further enables the user to accept or reject a system-matched user profile with a keyboard on the mobile computing device.

17. The mobile social activity networking system of claim 12 wherein the system further enables the user to automatically reject a system-matched user profile based on a blocked list; the blocked list created and maintained by the user on the social activity networking application.

18. The mobile social activity networking system of claim 12 wherein the system further enables the user to automatically accept a system-matched user profile based on a preferred list; the preferred list created and maintained by the user on the social activity networking application.

19. The mobile social activity networking system of claim 12 wherein one of the activities is dating.

20. The mobile social activity networking system of claim 12 wherein one of the activities is playing sports.

21. The mobile social activity networking system of claim 12 wherein the system further enables the user to send an invitation to an event to another user, that is either a system-matched user or a connected user, and upon acceptance from the another user, the user and the another user agree to the time and place of the event.

22. The mobile social activity networking system of claim 12 wherein the system further enables the user to send an invitation to another user for an event at a time and place; and upon rejection from the another user, the system proposes at least one of an alternate time and an alternate place, and the system shares a calendar for the event; and upon acceptance from the connected user, the user and the another user agree to the time and place.

23. The mobile social activity networking system of claim 12,
wherein the system is further configured to enable:
messaging between a user and at least one of the system-matched users; and
wherein the system displays a list of messages when the user selects a messages tab from a menu in the social activity networking application on the mobile device, and enables the user to select a message from another user from the list, exchange messages with the another user; send an invitation for an event at a location to the another user; and agree on a time and place for the event.

24. The mobile social activity networking system of claim 12 wherein the system is further configured to facilitate the user to:
report to a system administrator via the social activity networking application when another user sends messages inappropriate content;
take a screenshot with an embedded verification code of the inappropriate content; and
send the screenshot to an administrator;
and wherein the system is configured to authenticate the screenshot with the embedded verification code, and the system administrator can determine appropriate action.

25. A mobile social activity networking system configured for facilitating event planning and coordination of activities between system-matched users of the system, the system configured for use by a plurality of users that each have a mobile computing device comprising a global positioning system receiver, with touch-activated graphic user interface, and with communications capability through telephony or wifi, or both,
wherein the system is configured to: enable a user to use the mobile computing device to download an activity networking application into the mobile computing device, and
wherein the system authenticates the download and authorizes the user, based on user data input via the activity networking application;
the system further configured to:
receive user input preferences, including demographic data defining other users that the user wants to interact with, preferred activities the user wants to engage in, the preferred geographic range of proximity to the user of other users that the user wants to communicate with;
retrieves GPS coordinates of the mobile computing devices using the global positioning system receivers;
calculates relative locations of the plurality of users through the mobile computing device that each of the plurality of users has, using the retrieved GPS coordinates;
identify user profiles of others in a database that conform to the user's input preferences as system-matched user profiles, wherein the user profiles comprise the relative locations of the plurality of the users; and
the system configured to enable the user to:
browse through the system-matched user profiles on the graphic user interface of the user's mobile computing device;
accept or reject a browsed user profile through the graphic user interface of the user's mobile computing device;
send a communication to an accepted browsed user profile; and
receive a responsive communication from the accepted user profile.

26. The mobile social activity networking system of claim 25 wherein the system performs a search of the database of users and retrieve user profiles that match the user preferences of the user as system-matched user profiles.

27. The mobile social activity networking system of claim 25 wherein the system computes a network matching score based on the user preferences of the user to determine system-matched user profiles.

28. The mobile social activity networking system of claim 25 wherein the system further enables the user to accept or reject a system-matched user profile with a gesture on a touch screen user interface of the mobile computing device.

29. The mobile social activity networking system of claim 25 wherein the system further enables the user to accept or reject a system-matched user profile using a keyboard of the mobile computing device.
